(19) United States
(12) Patent Application Publication
(10) Pub. No.: US 2005/0033736 A1
(43) Pub. Date: Feb. 10, 2005

(54) System and method for processing record related information

(76) Inventors: Constance Patricia Coates Carlin, Malvern, PA (US); Constance Elisabeth McDowell, Conshohocken, PA (US)

Correspondence Address: Alexander J. Burke;Intellectual Property Department, 5th Floor, 170 Wood Avenue South, Iselin, NJ, 08830, US

(21) Appl. No.: 10/842,611

(22) Filed: May 10, 2004

Related U.S. Application Data
(60) Provisional application No. 60/492,644, filed on Aug. 5, 2003.

(51) Int. Cl. G06F 17/30

(52) U.S. Cl. 707/3

(57) ABSTRACT

A system and method is disclosed for defining a set of predetermined comment codes for incorporation into database records to enhance processes and workflows. The system comprises a repository of records, including a plurality of records incorporating at least one comment identifier identifying a comment associated by a user with a particular record and provides additional information about a particular characteristic of the record, a search processor for searching the repository to identify a plurality of records incorporating at least one predetermined comment identifier in response to a user provided search query, and a task processor for assigning performance of a task comprising processing the identified plurality of records. The system may also include a report generator for generating a report identifying the plurality of records incorporating the predetermined comment identifier and for providing data representing the report in a format suitable for at least one of, display on a reproduction device, printing and electronic communication, in response to a user command.

### CROSS REFERENCE TO RELATED APPLICATIONS

This is a non-provisional application of provisional application Ser. No. 60/492,644 by Constance Patricia Carlin et al. filed Aug. 5, 2003.

### 1. FIELD OF THE INVENTION

The present invention relates to techniques for enhancing process and workflow in general. More specifically, the present invention relates to mechanisms for using comment codes entered on accounts/claim items to automate processes and enhance workflow in healthcare/financial management systems. However, the present invention is equally applicable in other industries where enhanced workflow is required.

### 2. BACKGROUND OF THE INVENTION

In many existing systems, comment codes may be entered and stored in records. Such is the case, for example, with financial records such as claim records associated with patient health care cost reimbursement. While these systems may enable extraction and export of record data and limited data manipulation, one drawback is that they are limited in that they support viewing of individual records. For example, in order to view a comment code entered in a record, a user needs to access and view the individual record. Thus, a user cannot simultaneously view and work with a set of records that include a specific comment code. A further drawback of such systems is that they fail to integrate comment codes into enterprise-wide computer applications. That is, there is no capability for assigning work-lists or generating reports based on comment codes entered and stored in records.

Accordingly, what is needed is a system which overcomes the aforementioned drawbacks.

### SUMMARY OF THE INVENTION

The present invention overcomes the above-noted and other deficiencies of the prior art by providing a method and system of record processing that involves providing a user with the ability to pre-define a set of comment codes to be incorporated into records, such as financial or clinical records, and use the incorporated comment codes as search criteria (filters) to select or identify a set of records of interest to the user. The records which are identified in the search are used to automate processes and drive work-lists.

A system of the invention includes a repository of records, including a plurality of records that include at least one comment identifier identifying a comment associated by a user with a particular record, the comment identifier providing additional information about a particular characteristic of the record. The system further includes a search processor for searching the repository, in response to a user provided search query, to identify a plurality of records incorporating at least one predetermined comment identifier of interest to a user. For those records identified by the search processor, a task processor assigns the performance of a task comprising processing the identified plurality of records. The system may also include a report generator for generating a report identifying the plurality of records incorporating the predetermined comment identifier and for providing data representing the report in a format suitable for display on a reproduction device and/or a printing and electronic communication, in response to a user command.

### BRIEF DESCRIPTION OF THE DRAWINGS

Referring now to the drawings in which like reference numbers represent corresponding parts throughout, where:

FIG. 1 is a schematic of an exemplary system embodiment;

FIG. 2 is a display image window of one embodiment of an allowable values maintenance (AVM) screen which illustrates an exemplary interface screen used by users to define a list of user-defined comment codes;

FIG. 3 is a display image window of one embodiment of a main menu screen shown to the user after the user has been authenticated by the healthcare/financial entity;

FIG. 4 illustrates one embodiment of a patient record locator screen that is displayed to a user in response to the user clicking on the “Patient Financial Overview” hyperlink of FIG. 3;

FIG. 5 illustrates one embodiment of a locator screen that is displayed to a user in response to the user utilizing search criteria supplied in patient record locator screen 400 of FIG. 4;

FIG. 6 illustrates one embodiment of a record summary display screen 600 that is shown to a user in response to the user clicking on the “OK” icon of FIG. 5;

FIG. 7 illustrates one embodiment of a record entry screen 700 that is shown to a user by clicking on the “Add/View Comments” icon 610 of FIG. 6;

FIG. 8 illustrates one embodiment of a report set-up screen 800 that is shown to a user for generating a report based on comment codes;

FIG. 9 is an exemplary report 900 generated in accordance with the search criteria shown in FIG. 8; and

FIG. 10 is an exemplary work-list which is generated in accordance with the search criteria provided in the exemplary display screen of FIG. 8.

### DETAILED DESCRIPTION OF THE INVENTION

The present invention incorporates a set of predetermined comment codes into database records to enhance processes and workflows. The system of the invention is suitable for use in information systems to create reports and/or work-lists based on a predetermined set of comment codes included as part of the database records.

The invention provides a number of advantages over prior art systems including the ability to drill down to specific records (e.g, accounts or patient records) based on one or more record related comment codes, the ability to integrate comment codes into enterprise-wide computer applications and the ability to create online reports, hard-copy reports and online interactive work-lists based on a record related comment code.

The disclosed elements to be described herein may be comprised of hardware portions (e.g., discrete electronic circuitry), software portions (e.g., computer programming), or any combination thereof. The system according to the invention may be implemented on any suitable computer running an operating system such as UNIX, Windows NT, Windows 2000 or Windows XP. Obviously, as technology changes, other computers and/or operating systems may be preferable in the future. The system as disclosed herein can be implemented using commercially available development tools.

One of skill in the art can appreciate that the display image windows illustrated in the figures for the embodiments of the present invention represent one possible arrangement and that other arrangements may be used which may include several image windows in place of one image window illustrated in the figures, or conversely one image window to represent several image windows, or different image window arrangements.

The system of the invention for processing records is described hereafter in a non-limiting context of a financial/healthcare information system.

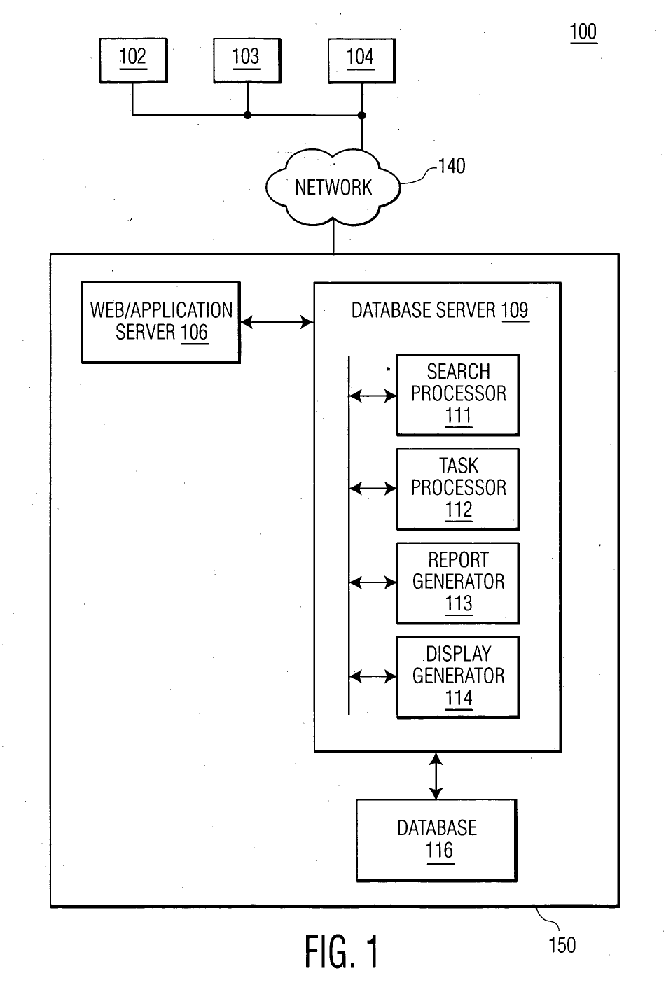

Referring now to FIG. 1, a schematic overview of system embodiment of the present invention is shown. In a system 100, user workstations 102, 103, 104 are connected to a financial/healthcare system 150 via a network 140. Financial/healthcare system 150 includes a Web/Application Server 106 running suitable web server software accommodates various forms of input, display and output, including voice, video, and text. System 150 further includes a database server 109 which includes a number of application programs for carrying out the method of the invention. Such application programs include a search processor 111 for searching database 116 to identify records which satisfy search criteria based on a set of pre-defined comment codes of interest to a user. As used herein, a processor comprises any one or combination of, hardware, firmware, and/or software. A processor acts upon information by manipulating, analyzing, converting or transmitting information for use by an executable procedure or an information device, and/or by routing the information to an output device. Database 116 stores record information associated with claims for reimbursement for healthcare services provided to a patient, a claim item related to a claim for reimbursement, an account, and a patient visit to a healthcare provider organization involving interaction between a healthcare provider organization and a patient. It is noted that database 116 may be a single database, or one that consists of multiple databases coupled via a network. The application programs further include a task processor 112 which is conventionally configured to create prioritized lists of record processing tasks for assignment to users based on criteria established in a master file. The task processor 112 is further configured to analyze those records which incorporate at least one pre-defined comment code and alter the prioritized list of record processing tasks. The task processor 112 may assign tasks

It is also noted that the servers 106, 109 may comprise more than one physical server, as required for capacity and redundancy, and that in some embodiments, more than one of the above servers may be logical servers residing on the same physical device. One or more database servers 109 may be at a remote location, and may communicate with the web/application server 106 through a local area or wide area network, such as network 140.

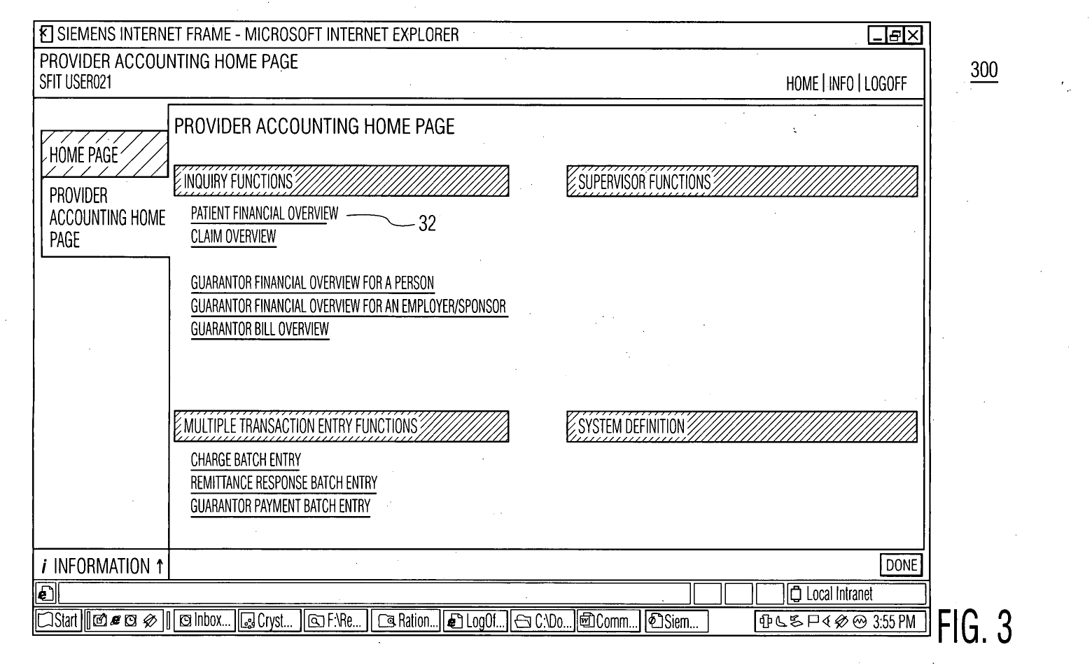

Users access to financial/healthcare system 150 is through the user's web browser at the user's workstation 102-104. There is typically a web address (URL) known to the user, and this is preferably stored either in the browser's “Favorites” list or as an icon on the user's desktop. The first screen that the user sees is the login screen (not shown). Users are typically required to provide a valid user identifier and password that is known to financial/healthcare system 150. Once this user has been authenticated by financial/healthcare system 150, a new browser window is opened (as exemplified by FIG. 3). The new browser window presents the user with a user interface (UI) tailored to his or her preferences and security privileges.

The invention generally operates in two-stages, a pre-configuration stage and an operational stage. At the pre-configuration stage, the user selects a set of comment codes which provide additional information to that already provided in the record. In the context of a healthcare/financial system 150, the comment codes preferably best describe actions which either need to be taken on a patient's record, have been taken on a patient's record, or are otherwise pertinent to the status of the patient associated with the record. The actions to be taken may be of a financial origin or related to the health of the patient.

In various embodiments, a user has the option of creating a list of comment codes, selecting a pre-defined list from a plurality of pre-defined lists of comment codes or otherwise customizing a list of comment codes from one of the plurality of pre-defined lists. Irrespective of how the list of comment codes is initially created, the comment code definitions are preferably stored in database 116 of the financial/healthcare system 150 for later use during the operational stage. The records of database 116 comprise information associated with, for example, a claim for reimbursement for healthcare services provided to a patient, a claim item of a claim for reimbursement, an account and a patient encounter with a healthcare provider organization involving interaction between a healthcare provider organization and a patient. The record can otherwise be related to financial or clinical information.

The pre-configuration stage for defining or creating a list of user specified comment codes is now described as follows.

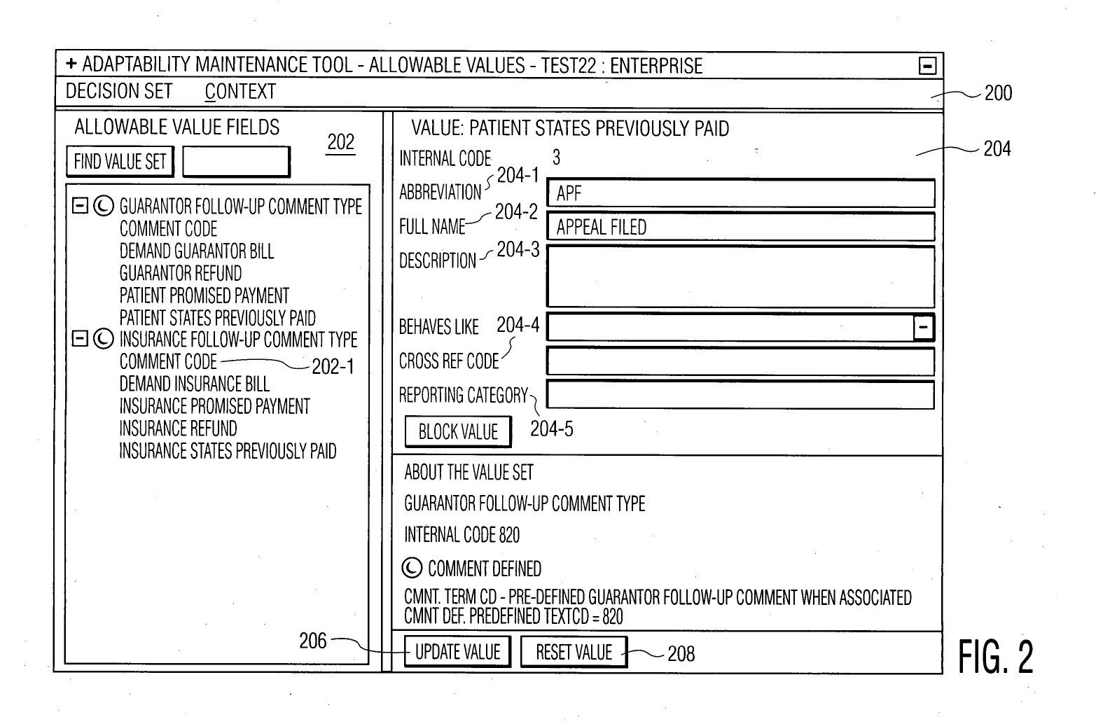

FIG. 2 is a display image window of one embodiment of an allowable values maintenance (AVM) screen 200 which illustrates an exemplary user interface (UI) screen to specify a set of user-defined comment codes for later use during an operational stage. The display image window 200, which is provided as a MicroSoft Windows™-type display in the exemplary embodiment, provides a template for entry of user-defined comment codes.

Table I lists some exemplary comment codes that may be created by a user for use in financial/healthcare system 150.

TABLE I

| Comment Code | Comment Code Description |
|---|---|
| APF | Appeal filed |
| BAD | Bad address |
| BKE | Bankruptcy filed |
| BLD | Billed to Medical Group |
| BNA | Billed No Authorization |
| BNR | Billed No Report |
| BWA | Billed with Authorization |
| BWR | Billed with Report |
| CCL | Cancelled Collections |
| GRF | Guarantor Refund |
| REF | Request Refund |
| RFP | Refund Processed |
| CTC | Clinical Trial Candidate |
| DCN | Dietary Consult Needed |
| CMF | Case Management |

With continued reference to FIG. 2, AVM screen 200 is divided into a left hand 202 and a right hand 204 portion. The majority of the left portion 202 of AVM screen 200 consists of a tree structure where the line items of the tree structure correspond to a particular category used in financial/healthcare system 150. Assume the multiplicity of categories shown, the comment code category 202-1 represents the category of interest.

The right hand portion 204 of AVM screen 200 provides a user with the ability to define or create a list of comment codes of interest to the user in comment code category 202-1.

To illustrate how a particular comment code may be determined by a user for incorporation into a user-defined comment code list, the process is described for the appeal filed or “APF” comment code listed in the first row of Table I above.

Creating a comment code definition for the “APF” comment code via AVM screen 200 operates as follows. To create a comment code definition using AVM screen 200, certain fields are required and others are optional and may be filled in at the discretion of the user.

A first required field of AVM screen 200 is the “Abbreviation” field 204-1, which is a field for entering a short form of the full name of the comment code (e.g., “APF”). The “Abbreviation” field 204-1 value (e.g., “APF”) is typically used in screens or reports where space is limited.

The next field is the “Full Name” field 204-2, which is a field for entering the full name of the comment code (e.g., “Appeal Filed”). This field is typically used in drop-down lists in various user interface screens.

The next field is the “Description” field 204-3, which is an optional field that may be used to further describe the comment code.

The next field is the “Cross Ref code” field 204-4, which is another optional field that references an industry-standard value, such as, for example, the ISO numeric codes that map to specific countries.

The next field is the “Reporting Category” field 204-5, which is another optional field that may be used to create groupings of allowable values for reporting purposes.

After reviewing the entered information, the user may accept the provided information by clicking-on the “Update Value” button 206, or otherwise reject the provided information by clicking on the “Reset Value” button 208.

The above steps may be repeated to define additional comment codes for incorporation into a comment code list of interest to the user such as the list described at table I. Once the user has entered a complete list of comment codes into the financial/healthcare system 150, the pre-configuration stage is considered to be complete.

Next, during the operational stage, a user adds the previously defined comment codes, established during pre-configuration, into various database records as needed. Once the process of adding comment codes to records is complete, the user may thereafter run reports (on-line, hardcopy) and generate work-lists using comment codes as search criteria to qualify (filter) records.

The process of entering comment codes into particular records is now described in accordance with FIG. 3.

FIG. 3 is a display image window of one embodiment of a screen 300 that is shown to a user in response to the user clicking on an icon on the user's desktop. FIG. 3 serves a number of functions for locating data in database 116 of financial/healthcare system 150 including a function relevant to the invention of locating individual client records for the purpose of entering comment codes into various records. To locate patient records of interest to a user in financial/healthcare system 150, a user clicks on the “Patient Financial Overview” hyperlink 32.

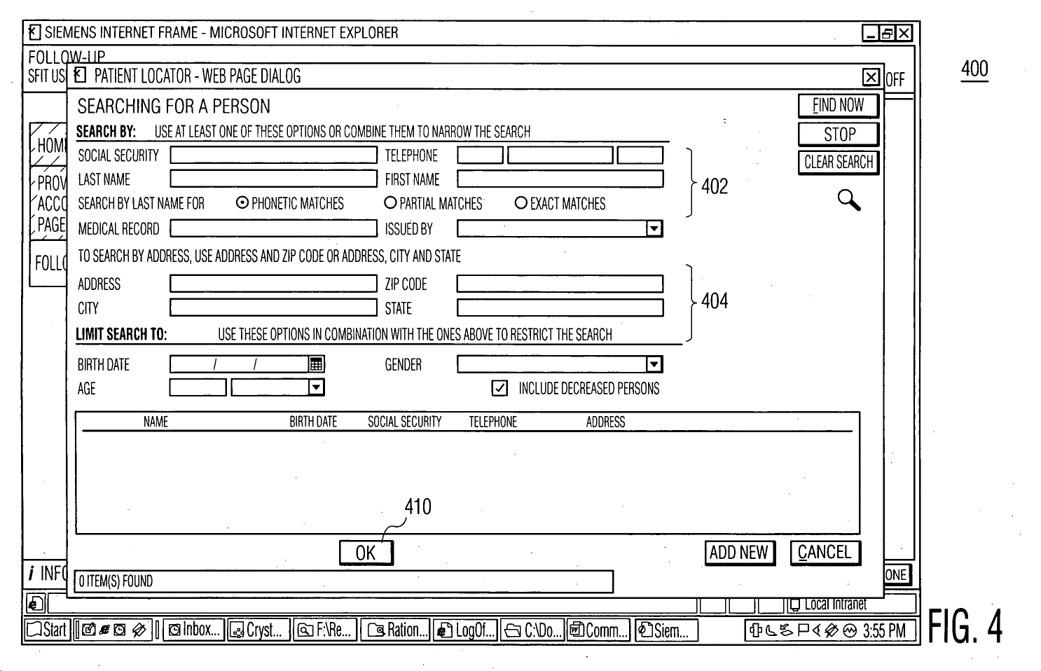

FIG. 4 is a display image window of one embodiment of a patient record locator screen 400 that is shown to a user in response to the user clicking on the “Patient Financial Overview” hyperlink 32 of FIG. 3. The patient locator screen 400 is in the form of a search template that allows a user to enter information to search for a particular patient record in database 116 of financial/healthcare system 150. Key words, or qualifiers, such as those found in fields 402 and 404 of FIG. 4, or other criteria may be used to search for client records stored in the database 116. When a user is satisfied with the search query as constructed, the search may be activated by pressing the “OK” icon 410. In response, the financial/healthcare system 150 performs a search of database 1] 6 to retrieves the item(s) found and display a listing of the found item(s) for the user. It is noted that in addition to searching for patient records, the search can be directed to searching for organization records or physician records.

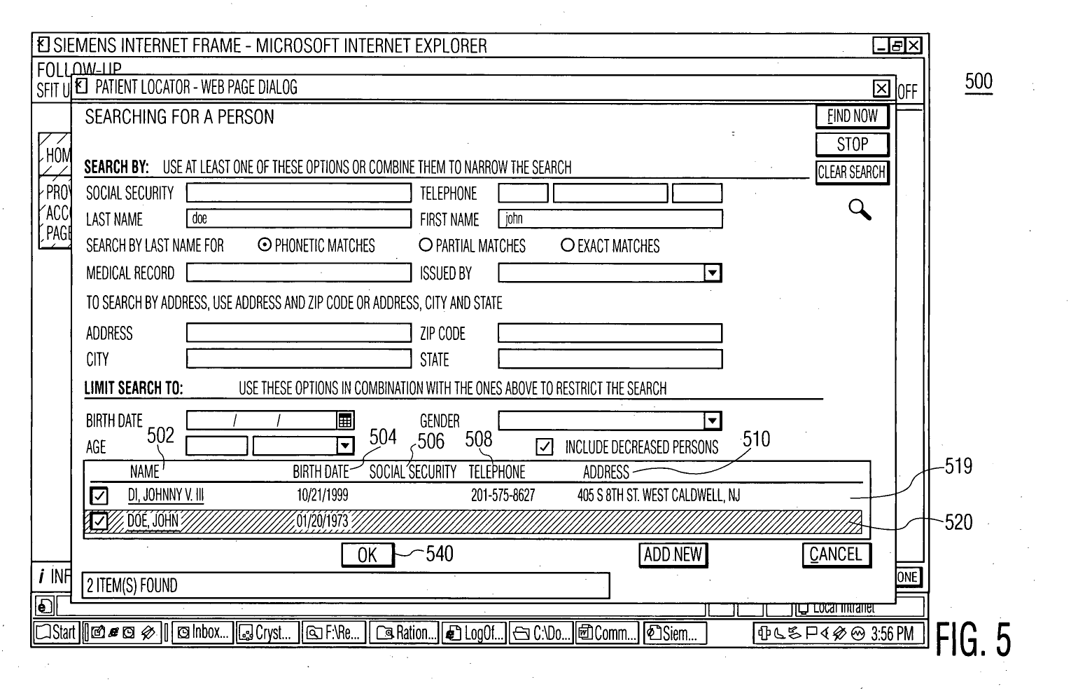

FIG. 5 is a display image window of one embodiment of a screen 500 that is shown to a user in the case where one or more items are found in response to performing a search of database 116 using the search criteria supplied in patient record locator screen 400. In the example shown, two records are located 519, 520 in response to the search criteria used. The two records shown include a number of fields including the person's name 502, birth date 504, social security number 506, telephone 508 and address 510.

From among the records being displayed, the user may highlight any record by checking the associated check box and clicking on the “OK” icon 540. It is noted that if no matches are found using the search criteria, a message is displayed at the bottom of screen 500 indicating that no matches were found.

In the example shown, from among the two records displayed 519, 520 in FIG. 5, the client record 520 for “John Doe” is highlighted for selection by the user.

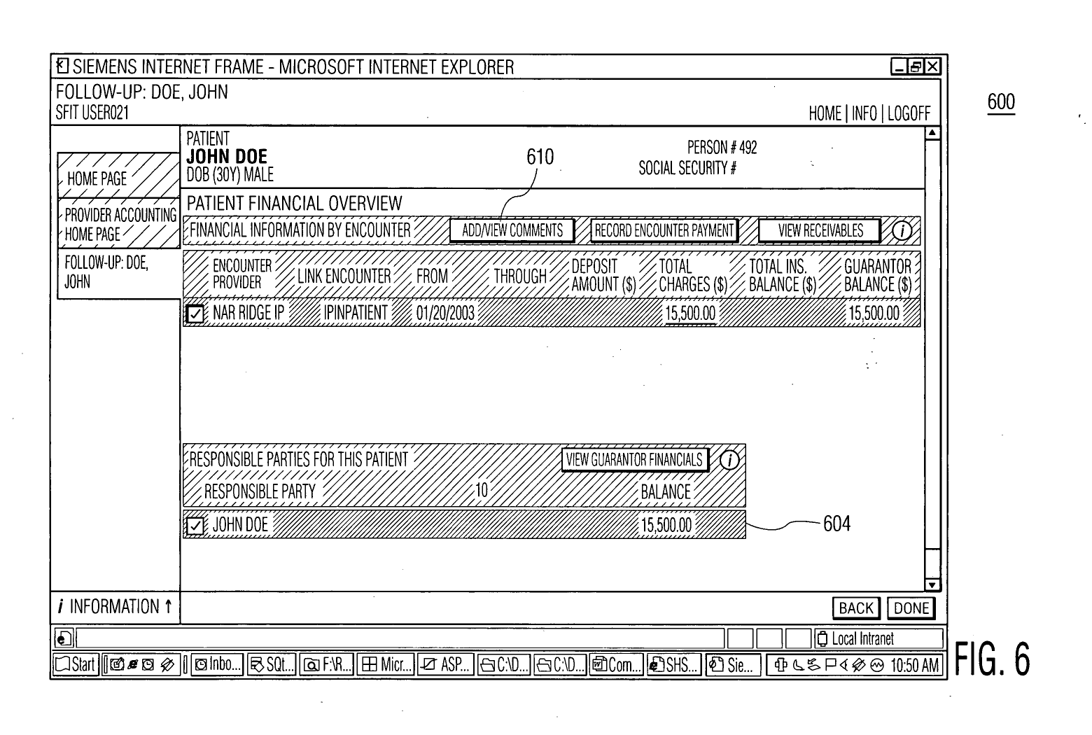

FIG. 6 is a display image window of one embodiment of a record summary display screen 600 that is shown to a user in response to the user clicking on the “OK” icon 540 of FIG. 5. In the present example, the record summary display screen 600 illustrates financial information 604 related to patient “John Doe”. Financial information 604 represents the guarantors registered for “John Doe”. In this case, “John Doe” is his own guarantor. If “John Doe” had insurance coverage, the insurances would be listed as well. To add one or more pre-defined comments, established during pre-configuration, to the record for patient “John Doe”, a user clicks on the “Add/View Comments” icon 610 of FIG. 6.

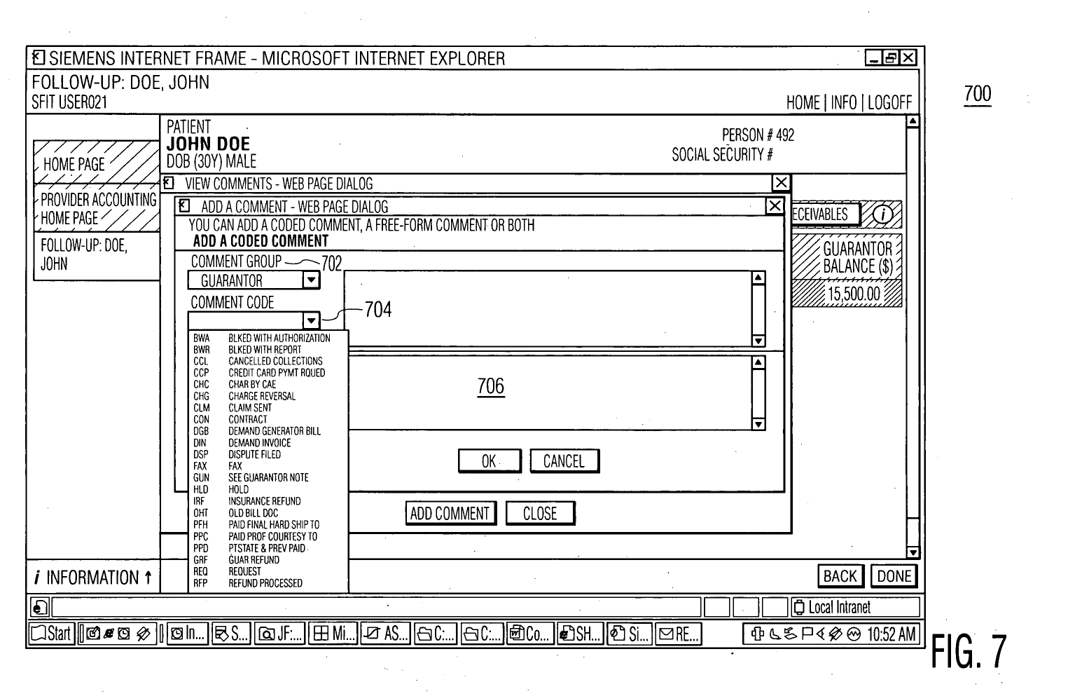

FIG. 7 is a display image window of one embodiment of a screen that is shown to a user by clicking on the “Add/View Comments” icon 610 of FIG. 6. In the example shown, FIG. 7 is the screen shown to a user for the client “John Doe”. To enter a comment code into the record for “John Doe”, a user first selects a comment code group 702. Upon selecting a comment code group from the drop down list 702, a list of available comment codes associated with the selected comment code group 702 is displayed in drop down list 704. In the instant example, the comment code group “Guarantor” is selected and its associated drop down list 704 is shown.

The user may select a pre-defined comment code from the dropdown list 704 and may also enter a free form comment into text entry area 706 in addition to or instead of selecting a pre-defined comment code.

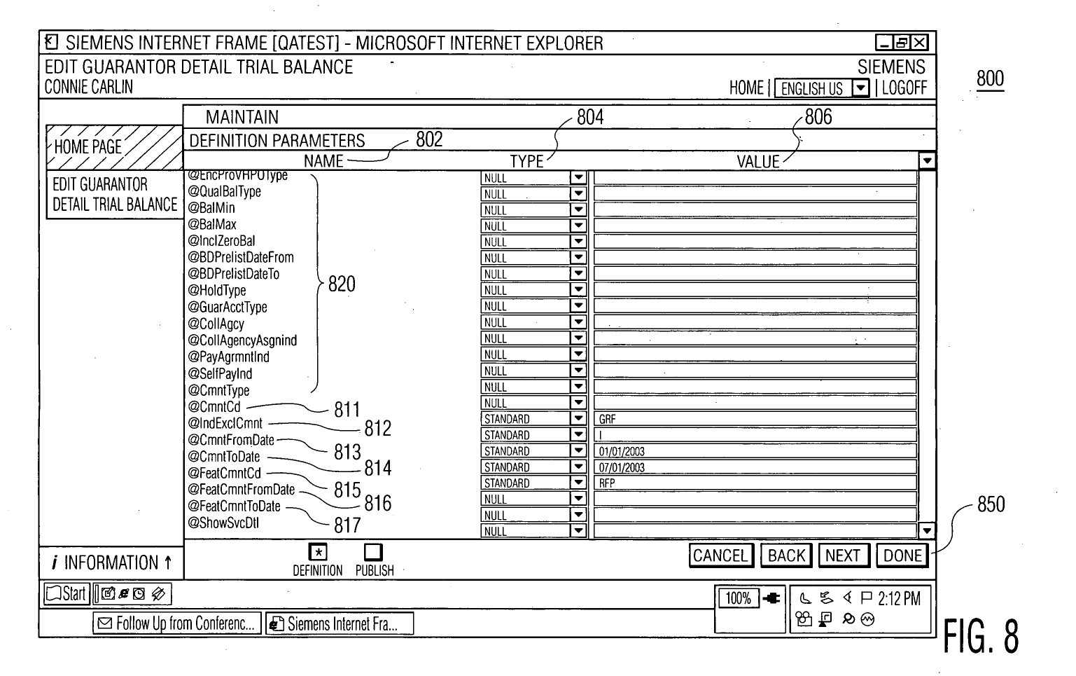

As described above, once the comment codes have been added to records as needed, the user has the ability to generate various reports. FIG. 8 is a display image window of one embodiment of a report set-up screen 800 that is shown to a user for generating a report based utilizing the pre-defined comment codes as search criteria. To generate a report, a user builds a search query by selecting one or more parameters defined in the first column 802 labeled “Name” which serve as qualifiers (i.e., filters) in the search query. It is noted that in the embodiment of the report set-up screen 800, seven of the twenty-three parameters shown are relevant to user provided comment codes, as identified by labels 811-817. The other sixteen parameters are related to other aspects of the financial/healthcare system 150. To build a search query for generating reports, one or more of the seven comment code related parameters 811-817 may be used in addition to incorporating other parameters which bear no relation to comment codes, generally identified with label 820. These parameters 820 are directed to aspects including a particular patient identifier, a particular date range, a particular healthcare payer organization, a particular healthcare provider organization, a particular medical record identifier, a particular social security number, particular patient physical characteristics and particular patient clinical characteristics.

The seven comment code related parameters 811-817 which are germane to the present invention are defined as follows.

TABLE II

| Parameter Name | Label | Definition | Explanation |
|---|---|---|---|
| @CmtCd | 811 | Allows a user to qualify database | Used strictly as a |
| | | records based on the value | database record |
| | | specified. | qualifier based on one |
| | | | of the user defined |
| | | | comment codes |
| | | | supplied during pre- |
| | | | configuration. |
| @InclExclCmtCd | 812 | Allows a user to include or exclude | A type value of “1” |
| | | a particular comment code entered | could indicate that the |
| | | into the data entry field. | comment code entered |
| | | | into the data entry field |
| | | | be include. Conversely, |
| | | | a value of “0” could |
| | | | indicate exclusion of |
| | | | the entered comment |
| | | | code. |
| @CmtCdFromDate, | 813 | Allows a user to enter a date range | |
| @CmtCdToDate | 814 | to limit selection to comments | |
| | | entered during that date range. This | |
| | | date range is associated with the | |
| | | @CmtCd parameter. | |
| @FeaturedCmtCd | 815 | Allows a user to flag (highlight) line | A user qualifies |
| | | items in reports based on the value | database records based |
| | | specifed. | on the @CmtCd |
| | | | parameter, and from the |
| | | | qualified list a user has |
| | | | the option of |
| | | | highlighting records in |
| | | | the list. |
| @FeaturedCmtCdFromDate, | 816 | Allows a user to enter a date range | |
| @FeaturedCmtCdDateTo | 817 | to limit featuring to comments | |
| | | entered during that date range. This | |
| | | date range is associated with the | |
| | | @FeaturedCmtCd parameter | |

The report set-up screen 800 of FIG. 8 further includes a second column 804 labeled “type” that further defines the parameter value, such as “Null” or “Standard”. The “Null” parameter type is the default value for the parameter which indicates that the associated parameter listed in the first row 802 is not used in the search query. The “type” may be changed by a user from “Null” to “Standard” whenever the parameter is intended for use in a search query.

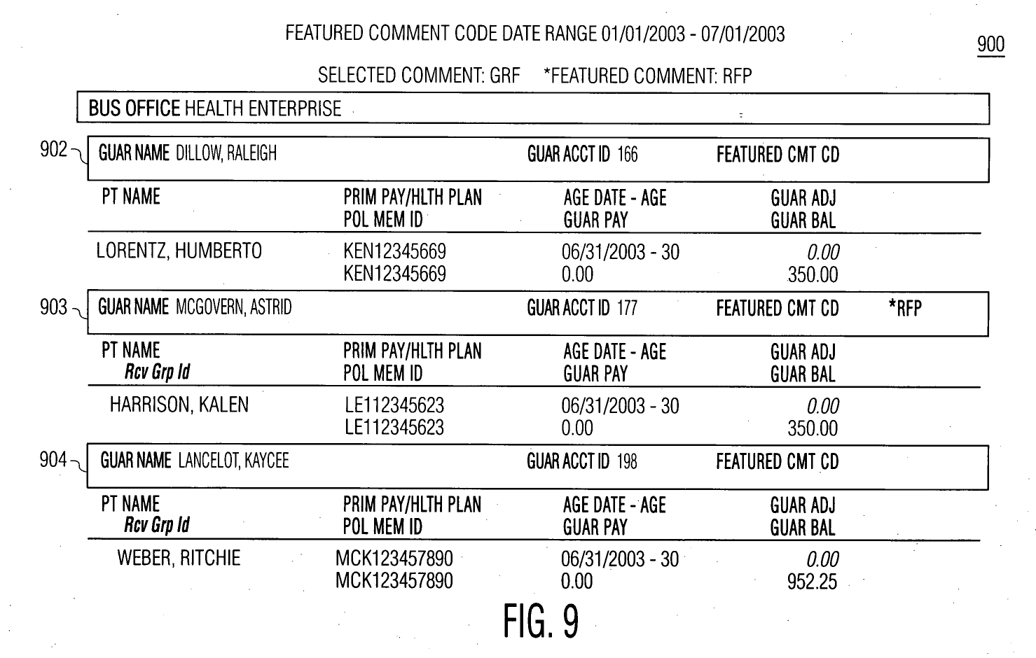

The third column 806, labeled “Value”, is provided to allow a user to enter a search query parameter value. In the example shown at report set-up screen 800 of FIG. 8, a user has selected five 811-815 of the seven comment code parameters for use in formulating a search query. In the example shown, the user has elected to qualify (i.e., filter) records based on the guaranteed refund, or in short form, “GRF” comment code. Therefore, those records which include the “GRF” comment code are included in the search result. To qualify records based on the “GRF” comment code, the parameter value “GRF” is entered into the third column 806 of report set-up screen 800 as shown. In addition to selecting “GRF” as a qualifying comment code, the user further elects to use the “RFP” comment code as a flag to a reader of the final report (as exemplified by FIG. 9, report 900). In this case, those records in the final report that include both the “GRF” comment code and the “RFP” comment code is highlighted in the report 900. In the example shown, the user further provides a date range 813, 814 to include those records having a “GRF” code entered between the start date of Jan. 1, 2003 and an end date of Jul. 1, 2003. In the example shown, the user has decided not to specify a date range 816, 817 for the selected featured comment code (e.g., “RFP”).

When a user is satisfied with the search query as constructed, the search may be activated by pressing the “Done” icon 850. In response, the search processor 111 (FIG. 1) searches database 116 to identify a plurality of records which satisfy the search query.

From the search results, the user has the option of generating reports, via user command, in various formats including a hard-copy report and/or an on-line report and/or electronically mailed to a user. The user has the further option of requesting report information to be added to a work-list task sequence to be executed by a worker or to be automatically executed via task processor 112. In lieu of generating hard copy and on-line reports in real-time, via user command, the user has the further option of scheduling the generation of such reports for a specific day.

FIG. 9 is an exemplary report 900 generated by report generator 113 (see FIG. 1) in accordance with the search criteria shown in report set-up screen 800 of FIG. 8. The report generator 113, in one embodiment, is enabled through a built-in industry standard reporting engine, Crystal Reports in combination with SQL queries to filter, join tables and derive data for the reports. A job scheduler program can be set up to automatically initiate the running of the reports.

With continued reference to FIG. 9, report 900 includes three records 902-904. As discussed above, report 900 could be displayed to a user in any number of formats in accordance with a user's preference including displaying the report 900 on an electronic device, such as display generator 114, and/or as a hard-copy report and/or electronically mailed to the user. As shown, the three records 902-904 of report 900 display receivables which have been qualified (filtered) in accordance with the parameter values specified by the user at report set-up screen 800 of FIG. 8. Receivables are the basic unit of the patient accounts receivable. The receivable is the amount owed by a responsible party (either guarantor or insurance) for a particular set or allocation of charges.

One search criteria employed by the user in the present example to qualify (filter) records is the @CmtCd parameter 811. In the present example, the user decides to select the comment code “GRF” for the value of the @CmtCd parameter 811 at report set-up screen 800 of FIG. 8. As such, those records that include the “GRF” comment code survive the first search criteria employed. Stated in the alternative, any record that does not include the “GRF” comment code is excluded from the search result.

A second search criteria employed by the user in the present example is the selection of a date range associated with the @CmtCd parameter 811. In particular, the user selects a date range filter by specifying parameter values for the @CmntFromDate parameter 813 and the @CmntToDate parameter 814 at report set-up screen 800. These parameters are associated with the @CmtCd parameter 811 and allow the user to enter a date range to limit selection to those comments entered during the specified date range. In the example, the date range specified by the user is Jan. 1, 2003 (start date) to Jul. 1, 2003 (end date) for the comment code “GRF”.

In addition to specifying the various search criteria described above, in the present example, the user has further determined to highlight (flag) those records in the search result that include the “RFP” comment code. To do so, the user utilizes the featured comment code parameter @FeaturedCmtCd 815 and assigns it a value of “RFP”. It is noted that this parameter does not filter or exclude records but rather serves to highlight those records of particular interest to the user.

In the present example, the three records shown in report 900, namely records 902-904 survived the search criteria applied by the user. In addition, record 903 is highlighted, as it was determined to further include the “RFP” comment code.

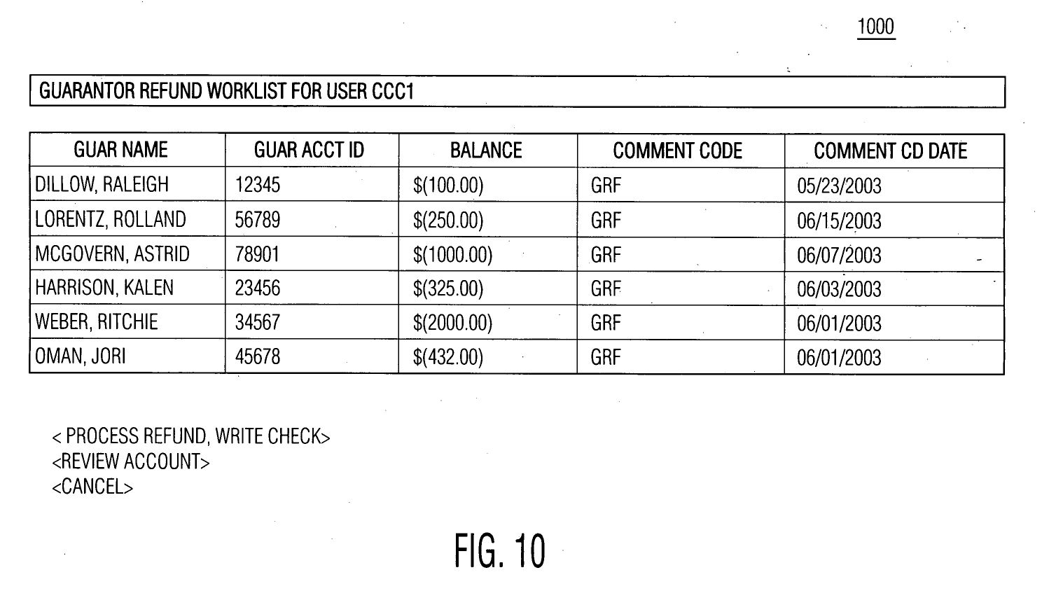

FIG. 10 is an exemplary work-list 1000 which is generated in accordance with the search criteria provided in the report set-up screen of FIG. 8. The work-list 1000 shows the set of guarantor accounts which have a “GRF” comment code entered between the start date of Jan. 1, 2003 and end date of Jul. 1, 2003. In one embodiment, hyperlinks are attached to these fields which would take the user to a refund screen. In this manner, it is shown that the comment codes are incorporated into the database records to modify and enhance processes and workflows.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A system for processing records, comprising:
a repository of records, including a plurality of records incorporating at least one comment identifier identifying a comment associated by a user with a particular record and providing additional information about a particular characteristic of said particular record;
a search processor for searching said repository to identify a plurality of records incorporating said at least one predetermined comment identifier in response to a user provided search query; and
a task processor for assigning performance of a task comprising processing said identified plurality of records.

2. A system according to claim 1, wherein said processing of said identified plurality of records further comprises prioritizing said identified plurality of records based at least upon said at least one comment identifier.

3. A system according to claim 1, wherein
said records comprise at least one of, (a) financial information and (b) clinical information.

4. A system according to claim 3, wherein
said records include financial information associated with at least one of,
(a) a claim for reimbursement for healthcare services provided to a patient, (b) a claim item of said claim for reimbursement, (c) an account, (d) a patient visit.

5. A system according to claim 1, wherein
said search processor searches medical records associated with at least one of, (a) different organizations, (b) different patients and (c) different physicians, in at least one repository to identify said plurality of records incorporating said at least one predetermined comment identifier.

6. A system according to claim 1, including
a report generator for generating a report identifying said plurality of records incorporating said at least one predetermined comment identifier and for providing data representing said report in a format suitable for at least one of, (a) display on a reproduction device, (b) printing and (c) electronic communication, in response to user command.

7. A system according to claim 1, wherein
said task processor assigns said task for at least one of, (a) automatic performance without user intervention and (b) performance by a healthcare worker.

8. A system according to claim 1, wherein
said task processor analyzes said identified plurality of records incorporating said at least one predetermined comment identifier and alters at least one of, (a) a sequence of financial record processing tasks and (b) a sequence of clinical record processing tasks, in response to said analysis.

9. A system according to claim 1, wherein said comment identifier provides additional information about a financial record characteristic including at least one of, (a) a past action taken on said financial record, and (b) a future action to be taken on said financial record, or (c) a comment pertinent to the person associated with the record.

10. A system according to claim 1, wherein
said comment identifier identifies a clinical record characteristic including at least one of, (a) particular patient requests made, (b) particular healthcare workers assigned to treat a patient and (c) a future clinical action to be taken.

11. A system according to claim 1, wherein
said search processor searches healthcare related records to identify said plurality of records incorporating said at least one predetermined comment identifier and incorporating another parameter including at least one of, (a) a particular patient identifier, (b) a particular date range, (c) a particular healthcare payer organization, (d) a particular healthcare provider organization, (e) a particular medical record identifier, (f) a particular social security number, (g) particular patient physical characteristics and (h) particular patient clinical characteristics.

12. A system according to claim 11, including
a display generator for initiating generation of data representing at least one display image enabling a user to select said at least one predetermined comment identifier and said another parameter as search criteria for searching said healthcare related records.

13. A system according to claim 1, including
a display generator for initiating generation of data representing at least one display image enabling a user to select a set of comment identifiers to be used and enabling a user to incorporate at least one comment identifier of said selected set into a record.

14. A system according to claim 13, wherein
said at least one display image enables said user to select a set of comment identifiers from a plurality of template sets of comment identifiers.

15. A system for processing records, comprising:
at least one repository of healthcare related records associated with at least one of, (a) different organizations, (b) different patients and (c) different physicians, said healthcare related records including a plurality of records incorporating at least one comment identifier identifying a comment associated by a user with a particular record and provides additional information about a particular characteristic of said particular record;
a search processor for searching said healthcare related records to identify a plurality of records incorporating said at least one predetermined comment identifier in response to user provided search query; and
a report generator for initiating generation of a report identifying said plurality of records incorporating said at least one predetermined comment identifier.

16. A system according to claim 14, wherein
said report generator provides data representing said report in a format suitable for at least one of, (a) display on a reproduction device, (b) printing and (c) electronic communication, in response to user command.

17. A system according to claim 14, including
a task processor for assigning performance of a task comprising processing said identified plurality of records.

18. A system according to claim 17, wherein said processing of said identified plurality of records further comprises prioritizing said identified plurality of records based at least upon said at least one comment identifier.

19. A system for processing records, comprising:
a display generator for initiating generation of data representing at least one display image enabling a user to select a comment identifier identifying a comment associated by a user with a particular record and providing additional information about a particular characteristic of said particular record, said at least one display image enabling a user to incorporate a comment identifier into a record for storage in a record repository;
a search processor for searching a plurality of stored records to identify a plurality of records incorporating at least one predetermined comment identifier in response to user command; and
a report generator for initiating generation of a report identifying said plurality of records incorporating said at least one predetermined comment identifier.

20. A system according to claim 19, wherein said records are healthcare related records.

21. A system for processing financial records, comprising:
a repository of financial records, including a plurality of financial records incorporating a comment identifier identifying a comment associated by a user with a particular financial record and providing additional information about a particular characteristic of said particular financial record;
a search processor for searching said repository to identify a plurality of financial records incorporating at least one predetermined comment identifier in response to user command; and
a task processor for analyzing said identified plurality of financial records incorporating said at least one predetermined comment identifier and for altering a record of at least one of, (a) financial record processing tasks and (b) clinical tasks, to be performed by a healthcare worker in response to said analysis.

22. A system according to claim 21, wherein
said task processor alters a recorded sequence of tasks, in response to said analysis.

23. A method for processing records, comprising the activities of:
incorporating at least one comment identifier in a plurality of records, said comment identifier identifying a comment associated by a user with a particular record and providing additional information about a particular characteristic of said particular record;
searching said plurality of records to identify records incorporating at least one predetermined comment identifier in response to a user provided search query; and
a task processor for assigning performance of a task comprising processing said identified records.

24. A system according to claim 23, wherein said processing of said identified plurality of records further comprises prioritizing said identified plurality of records based at least upon said at least one comment identifier.

25. A method for processing records, comprising the activities of:
incorporating at least one comment identifier in a plurality of healthcare related records, said comment identifier identifying a comment associated by a user with a particular healthcare related record and providing additional information about a particular characteristic of said particular healthcare related record, said plurality of healthcare related records being associated with at least one of, (a) different organizations, (b) different patients and (c) different physicians;
searching said healthcare related records to identify a plurality of records incorporating at least one predetermined comment identifier in response to a user provided search query; and
initiating generation of a report identifying said plurality of records incorporating said at least one predetermined comment identifier.

26. A method for processing financial records, comprising the activities of:
incorporating at least one comment identifier in a plurality of financial records, said comment identifier identifying a comment associated by a user with a particular financial record and providing additional information about a particular characteristic of said particular financial record;
searching said repository to identify a plurality of financial records incorporating at least one predetermined comment identifier in response to a user provided search query;
analyzing said identified plurality of financial records incorporating said predetermined comment identifier; and
altering a record of at least one of, (a) financial record processing tasks and (b) clinical tasks, to be performed by a healthcare worker in response to said analysis.

27. A method for processing records, comprising the activities of:
initiating generation of data representing at least one display image enabling a user to select a comment identifier identifying a comment associated by a user with a particular record and providing additional information about a particular characteristic of said particular record, and at least one display image enabling a user to incorporate a comment identifier into a record for storage in a record repository;
searching a plurality of stored records to identify a plurality of records incorporating at least one predetermined comment identifier in response to user command; and
initiating generation of a report identifying said plurality of records incorporating said at least one predetermined comment identifier.
